(19) United States
(12) Patent Application Publication
(10) Pub. No.: US 2015/0322850 A1
(43) Pub. Date: Nov. 12, 2015

(54) TURBOCHARGER AND CASING

(71) Applicant: General Electric Company, Schenectady, NY (US)

(72) Inventors: Harsha Vardhana, Bangalore (IN); Daniel Edward Loringer, Lawrence Park, PA (US); Suresha Kumar Panambur, Bangalore (IN); Paulraj Ramasamy, Bangalore (IN); Raghav Shrikant Kulkarni, Bangalore (IN); Krishna Lakshminarasimhan, Bangalore (IN); Amol Muralidhar Petakar, Bangalore (IN)

(73) Assignee: General Electric Company, Schenectady, NY (US)

(21) Appl. No.: 14/274,054

(22) Filed: May 9, 2014

(51) Int. Cl. F02B 39/00; F02B 37/00; F01D 25/00; F02B 39/08

(52) U.S. Cl. CPC F02B 39/005; F02B 39/08; F02B 37/00; F01D 25/005; F05D 2220/40; F05D 2240/24; F05D 2240/14; F05D 2260/232; F05D 2300/10

(57) ABSTRACT

Various methods and systems are provided for a turbocharger comprising a turbine disc rotatable about a rotational axis of the turbocharger, a compressor wheel mechanically coupled to the turbine disc via a shaft, a compressor casing including an air inlet and a blower casing formed as one piece, the air inlet configured to admit air to the compressor wheel, and a turbine casing housing the turbine disc, the turbine casing including a shroud surrounding the turbine disc.

### FIELD

Embodiments of the subject matter disclosed herein relate to turbochargers. Other embodiments relate to turbocharger turbine and compressor casings.

### BACKGROUND

Turbochargers may be used in an engine system to increase a pressure of air supplied to the engine for combustion. In one example, the turbocharger includes a turbine, coupled in an exhaust passage of the engine, which at least partially drives a compressor via a shaft to increase the intake air pressure. Exhaust gas passing through the turbine rotates the blades of a turbine disc mechanically coupled to a compressor wheel through the shaft. The performance of the turbine disc assembly may be achieved by controlling the blade tip clearance between the blades/buckets and a turbine shroud. Depending on operating conditions, the turbine disc may rotate at speeds exceeding 25,000 RPMs.

In the event that damage to the turbine releases fragments, these fragments may damage other components if the released fragments are not contained by, for example, a shroud. Material and packaging constraints may result in regions of the shroud that are unable to withstand the impact of a high-energy fragment release, particularly when the shroud is subject to the high temperatures. Different turbochargers may have varying shaft lengths and bearing sizes. As a result, different shrouds may be needed for different casings used for different turbochargers.

### BRIEF DESCRIPTION

In one embodiment, an apparatus comprises a compressor casing for a turbocharger and a turbine casing for the turbocharger. The compressor casing defines an air inlet and has a blower casing component. The air inlet is configured to admit air to a compressor wheel mechanically coupled to a turbine disc via a shaft, the turbine disc being rotatable about a rotational axis of the turbocharger. The turbine casing houses the turbine disc, and comprises a shroud component surrounding at least a portion of the turbine disc.

### BRIEF DESCRIPTION OF THE DRAWINGS

The invention will be better understood from reading the following description of non-limiting embodiments, with reference to the attached drawings, wherein below:

FIG. 1 shows a schematic diagram of a vehicle with a turbocharger according to an embodiment of the disclosure.

FIG. 2 shows a cross-sectional view of a turbocharger according to an embodiment of the disclosure.

FIG. 3 shows a cross-sectional view a compressor casing according to an embodiment of the disclosure.

FIG. 4 shows a cross-sectional view of a turbine casing according to a first embodiment of the disclosure.

FIG. 5 shows a cross-sectional view of a turbine casing according to a second embodiment of the disclosure.

FIG. 6 shows a cross-sectional view of a turbine casing according to a third embodiment of the disclosure.

FIG. 7 shows a cross-sectional side-view of a turbocharger casing according to an embodiment of the disclosure.

FIG. 8 shows a three-dimensional side view of a turbocharger casing according to an embodiment of the disclosure.

FIG. 9 shows a three-dimensional isometric view of a turbocharger casing according to an embodiment of the disclosure.

FIG. 10 shows an isometric view of an intermediate spacer of a turbocharger casing according to an embodiment of the disclosure.

FIG. 11 shows an isometric view of a portion of compressor casing according to an embodiment of the disclosure.

FIG. 12 shows an isometric view of a bearing bush of a turbocharger casing according to an embodiment of the disclosure.

### DETAILED DESCRIPTION

Embodiments of the subject matter disclosed herein relate to turbochargers. Other embodiments relate to turbocharger turbine and compressor casings. In one embodiment, an apparatus comprises a compressor casing and a turbine casing for a turbocharger. The compressor casing defines an air inlet and has a blower casing component, the air inlet configured to admit air to a compressor wheel mechanically coupled to a turbine disc via a shaft, the turbine disc rotatable about a rotational axis of the turbocharger. The turbine casing houses the turbine disc, the turbine casing comprising a shroud component surrounding at least a portion of the turbine disc. In one example, the turbine casing and the compressor casing may be part of a kit, separate from a turbocharger. In another example, the compressor casing and the turbine casing may be standalone components without being installed on a turbocharger. In yet another example, the turbine casing and the compressor casing may be included on a turbocharger. The turbocharger may be a stand-alone turbocharger or installed in an engine system of a vehicle.

The approach described herein may be employed in a variety of engine types, and a variety of engine-driven systems selected with reference to application specific criteria. Some of these systems may be stationary, while others may be on semi-mobile or mobile platforms. Semi-mobile platforms may be relocated between operational periods, such as mounted on flatbed trailers. Mobile platforms include self-propelled vehicles. Such vehicles can include on-road transportation vehicles, as well as mining equipment, marine vessels, rail vehicles, and other off-highway vehicles (OHV). For clarity of illustration, a locomotive may be used as an example of a mobile platform supporting a system incorporating an embodiment of the invention.

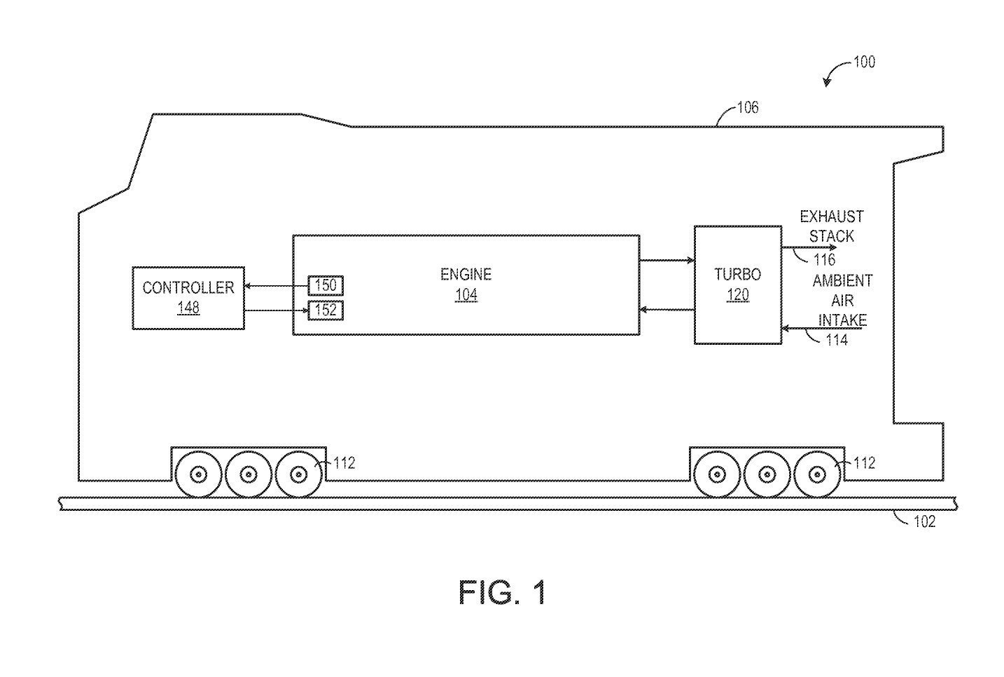

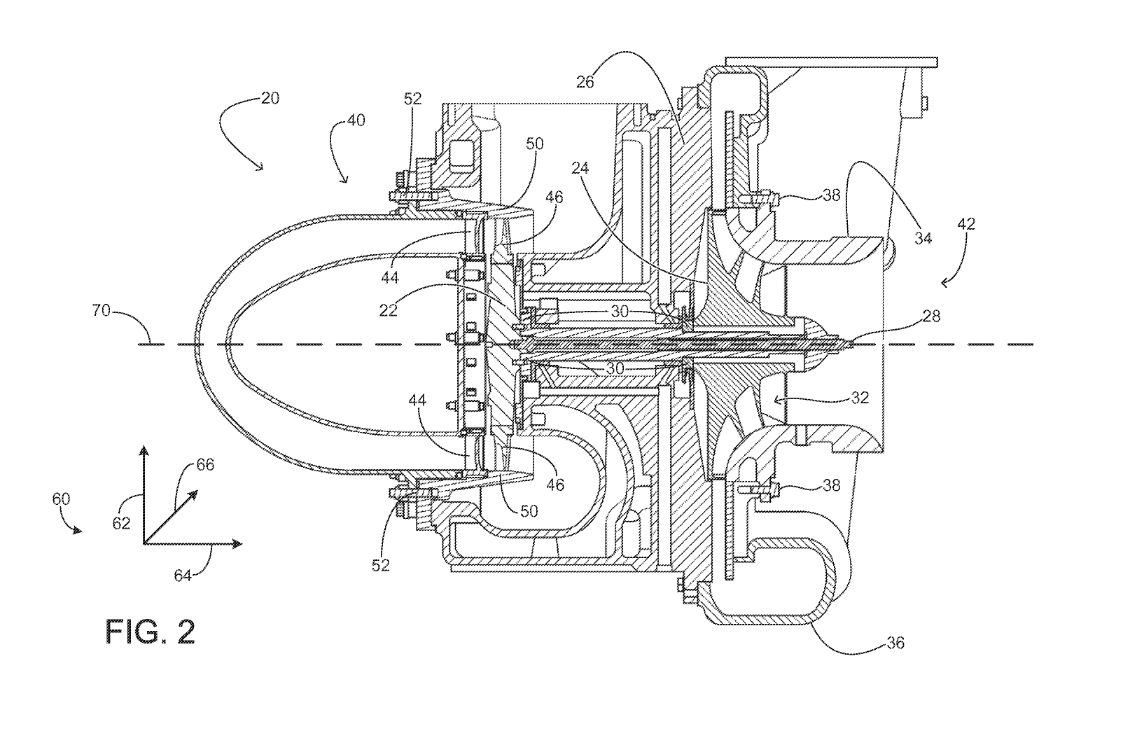

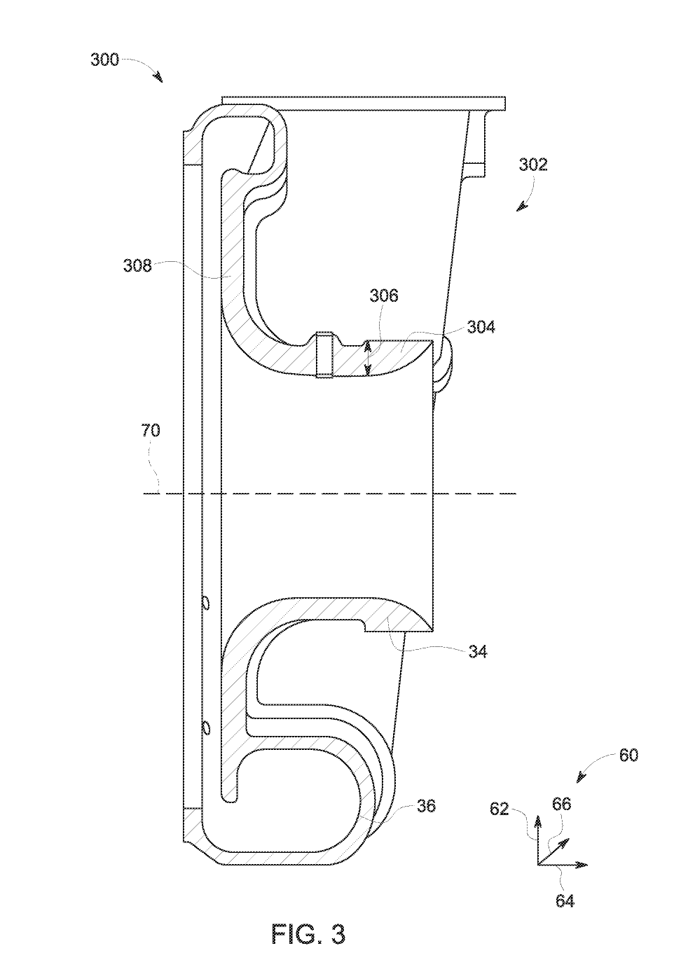

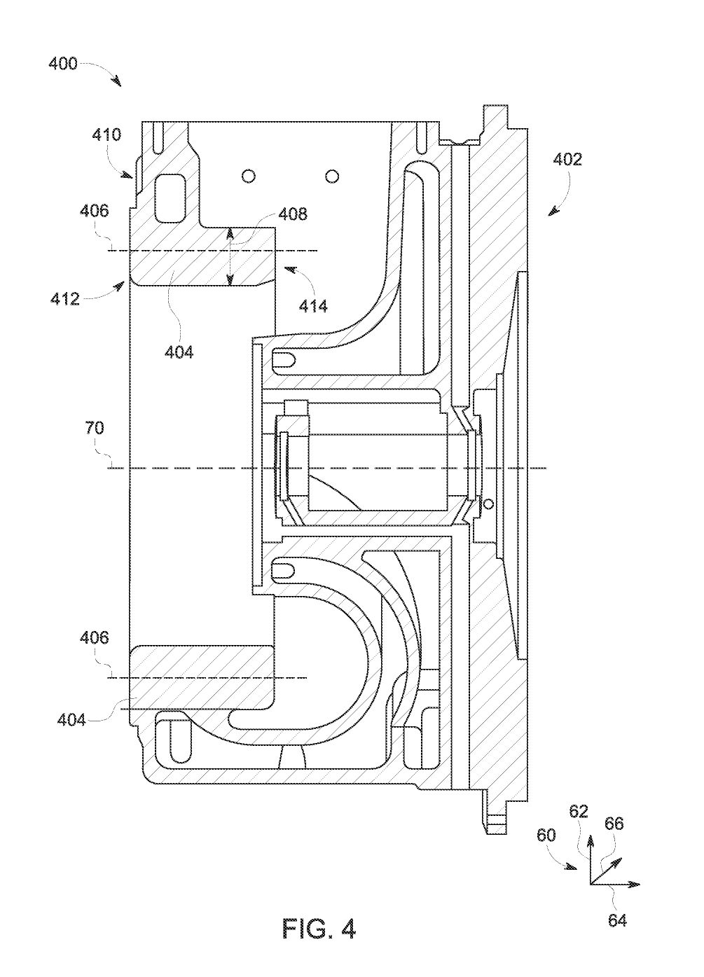

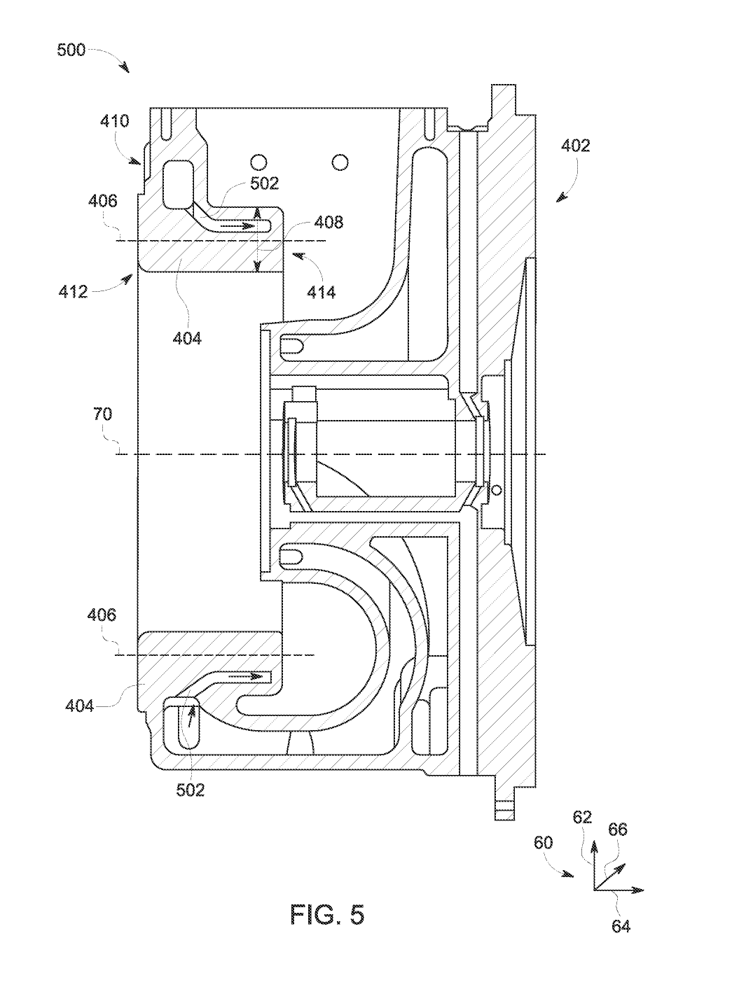

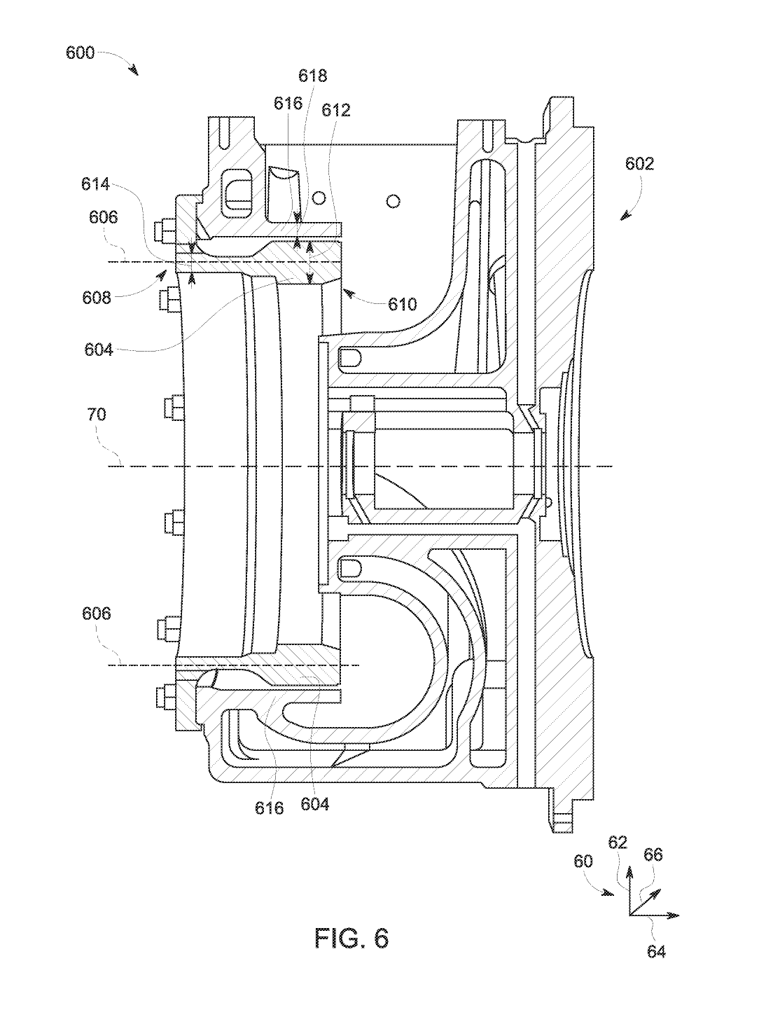

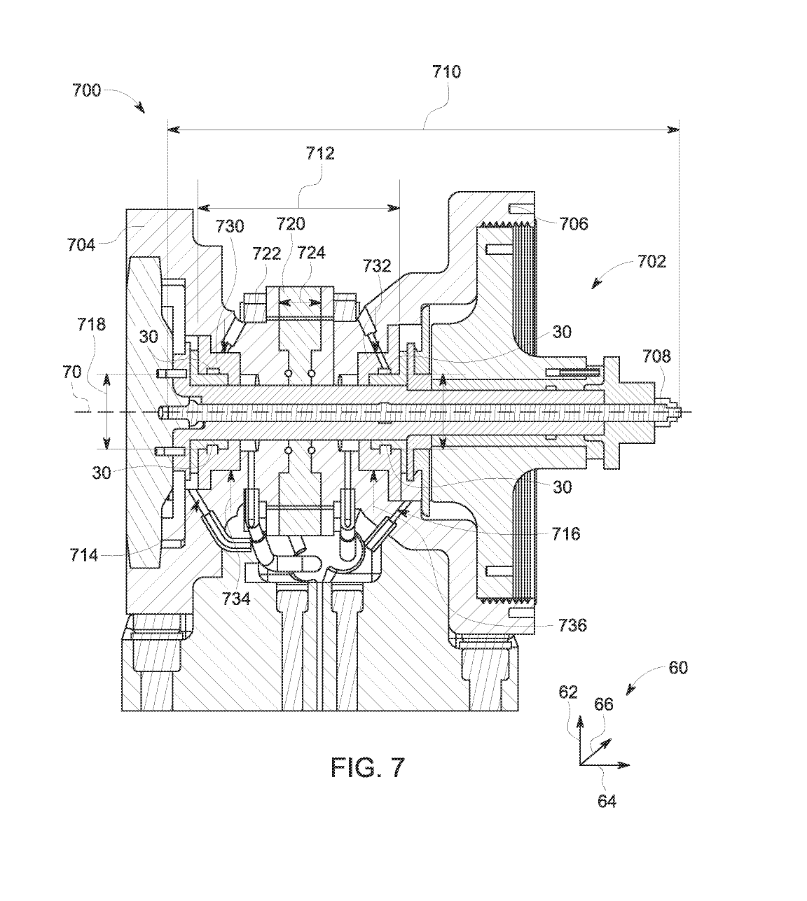

Aspects of the invention are disclosed with reference to the turbocharger shown in FIGS. 1-2. The turbocharger casing may include a turbine casing and a compressor casing. FIG. 3 shows a compressor casing with an integrated air inlet and blower casing component. References to an inlet, as used herein, refer to the structure and surfaces defining the pathway that is the inlet itself. A continuous wall eliminating or reducing a number of joints between an air inlet and a blower casing portion may have relatively increased strength for containing compressor wheel fragments during a compressor wheel burst event than a corresponding wall with joints and/or discontinuities. FIGS. 4-6 show various embodiments of a turbine casing for increasing containment capabilities of the turbine casing during a turbine disc burst event. For example, the turbine casing may include a shroud that is integrated with a remainder of the turbine casing (FIGS. 4-5) or a shroud coupled to a flange extending over the shroud (FIG. 6). In some embodiments, the turbine casing and the compressor casing may be separate and coupled to one another via an intermediate spacer. The intermediate spacer may be sized based on a shaft length of the turbocharger. As a result, a single turbine casing and compressor casing may be used in different sized turbochargers by utilizing different sized intermediate spacers. FIGS. 7-12 show the intermediate spacer and bearing bushing components, as well as their relative positioning with the turbine and compressor casings.

Before further discussion of the turbocharger casing embodiments, a positioning of a turbocharger in an engine system is shown. FIG. 1 shows a block diagram of an embodiment of a vehicle system 100 (e.g., a locomotive system), herein depicted as vehicle 106. The illustrated vehicle is a rail vehicle configured to run on a rail 102 via a plurality of wheels 112. As depicted, the vehicle includes an engine system with an engine 104.

The engine receives intake air for combustion from an intake passage 114. The intake passage receives ambient air from an air filter (not shown) that filters air from outside of the vehicle. Exhaust gas resulting from combustion in the engine is supplied to an exhaust passage 116. Exhaust gas flows through the exhaust passage, and out of an exhaust stack of the vehicle.

The engine system includes a turbocharger 120 (“TURBO”) that is arranged between the intake passage and the exhaust passage. The turbocharger increases air charge of ambient air drawn into the intake passage in order to provide greater charge density during combustion to increase power output and/or engine-operating efficiency. The turbocharger may include a compressor (not shown in FIG. 1) which is at least partially driven by a turbine (not shown in FIG. 1). While in this case a single turbocharger is shown, other systems may include multiple turbine and/or compressor stages. The turbocharger is described in greater detail with reference to FIG. 2.

In some embodiments, the engine system may include an exhaust gas treatment system coupled in the exhaust passage upstream or downstream of the turbocharger. In one example embodiment having a diesel engine, the exhaust gas treatment system may include a diesel oxidation catalyst (DOC) and a diesel particulate filter (DPF). In other embodiments, the exhaust gas treatment system may additionally or alternatively include one or more emission control devices. Such emission control devices may include a selective catalytic reduction (SCR) catalyst, three-way catalyst, NOₓ trap, as well as filters or other systems and devices.

A controller 148 may be employed to control various components related to the vehicle system. In one example, the controller includes a computer control system. The controller further includes computer readable storage media (not shown) including code for enabling on-board monitoring and control of rail vehicle operation. The controller, while overseeing control and management of the vehicle system, may receive signals from a variety of sensors 150, as further elaborated herein, to determine operating parameters and operating conditions, and correspondingly adjust various engine actuators 152 to control operation of the vehicle. For example, the controller may receive signals from various engine sensors including, but not limited to, engine speed, engine load, boost pressure, exhaust pressure, ambient pressure, exhaust temperature, and the like. Correspondingly, the controller may control aspects and operations of the vehicle system by sending commands to various components such as fraction motors, alternator, cylinder valves, throttle, and the like.

FIG. 2 shows a cross-sectional view of one embodiment of a turbocharger 20 that may be coupled to an engine, such as the turbocharger described above with reference to FIG. 1. In one example, the turbocharger may bolt to the engine. In another example, the turbocharger may couple between the exhaust passage and the intake passage of the engine. In other examples, the turbocharger may couple to the engine by any another suitable manner based at least in part on application specific criteria. FIG. 2 is drawn to scale in one non-limiting embodiment. It will be understood, however, that turbocharger embodiments that differ from FIG. 2 are also contemplated. FIG. 2 shows a coordinate axis 60 including a vertical axis 62, a horizontal axis 64, and a lateral axis 66.

The turbocharger includes a turbine 40 and a compressor 42. Exhaust gases from the engine pass through the turbine, and energy from the exhaust gases is converted into rotational kinetic energy to rotate a shaft 28 which, in turn, drives the compressor. Ambient intake air is compressed (e.g., pressure of the air is increased) as it is drawn through the rotating compressor such that a greater mass of air may be delivered to the cylinders of the engine. The turbocharger includes a rotational axis 70 around which the shaft rotates.

The turbocharger includes a casing 26 and bearings 30. In some embodiments, the turbine and the compressor may have separate casings which are bolted together, for example, such that a single unit (e.g., turbocharger) is formed. The turbocharger casing (or the compressor and/or turbine casing of the turbocharger casing) may be single-walled. The term ‘single-walled’ is used herein to indicate that the component described does not include a breech-resistant second or outer wall in addition to its function-defining main wall. To put it another way, no second or outer wall is required for a single-walled component to perform the containment function—i.e., a “single-walled” component by itself is able to contain fragments that are released during all operating modes of the engine systems here disclosed.

As an example, the turbine may have a casing made of cast iron and the compressor may have a casing made of a relatively more ductile material (such as ductile iron or ductile steel). Ductility values of materials may be found in standard engineering reference literature.

‘Ductile iron’ is synonymous with ‘ductile cast iron’, ‘nodular cast iron’, ‘spheroidal graphite iron’, ‘spherulitic graphite cast iron’, and so-called ‘SG iron’. Compared to other cast-iron variants, ductile iron is significantly more flexible and elastic due to its nodular (e.g., spherical) graphitic inclusions. In contrast, the graphitic inclusions of grey cast iron are flake-like.

Like grey cast iron, ductile iron also exhibits high strength and a low coefficient of linear thermal expansion (substantially 1.28×10⁻⁵ per K from 293 to 572 K), which is within 10% of the value for grey cast iron). The terms ‘substantially’ and ‘about’ are applied herein to a median value of a narrow range—e.g., a range of ±5% or ±10% of the median value. In addition, the ultimate tensile strength of ductile iron, from about 410 MPa (about and including 410 MPa and above), is significantly higher than that of grey cast iron, at 138 MPa. Other suitable ductile iron specimens have ultimate tensile strengths above about 345 MPa. Still other suitable ductile iron specimens have ultimate tensile strengths in a range of from about 414 MPa for ferritic grades to more than about 1380 MPa for martensitic grades. The ultimate tensile strength, or ‘tensile strength’, refers to the maximum load in tension that a material will withstand prior to fracture. It may be calculated by dividing the maximum load applied during a tensile test by the original cross-sectional area of the tested sample.

The yield strength of ductile iron, from about 280 MPa (about and including 280 MPa and above), is significantly higher than that of grey cast iron, at 83 MPa. Thus, in one particular embodiment, the ductile iron may have an ultimate tensile strength of greater than about 410 MPa and a yield strength of greater than about 280 MPa. Other suitable ductile iron specimens have yield strengths above about 200 MPa. Still other suitable ductile iron specimens have yield strengths in a range from about 275 MPa for ferritic grades to about 620 MPa for martensitic grades, or higher. Further, the percent elongation of ductile iron, 15 to 18%, is much greater than that of grey cast iron, at 0.5%. In one embodiment, this material may have an percent elongation of greater than 10%; in other embodiments, it may have a percent elongation from about 10% to about 15%, or from about 15% to about 18%, or from about 18% to about 20%, or from about 20% to about 25%, or greater than about 25%. In one embodiment, the material may have a modulus of elasticity in a range from about 162 gigapascals (GPa) to about 170 GPa. In other embodiments, the modulus of elasticity may be greater than 170 GPa.

Ductile iron has a dynamic elastic modulus (DEM) in a range from about 162 to 186 GPa. In some specimens, the DEM may fall within a narrower range—e.g., 170 to 178 GPa. The DEM indicates the high frequency limit of the modulus of elasticity, as measured by a resonant frequency test. For most ductile iron specimens, Poisson's ratio is about 0.275. Poisson's ratio is the ratio of the lateral elastic strain to the longitudinal elastic strain produced during a tensile test. In one embodiment, a suitable ductile iron casting—in the form of an air inlet, turbine casing, or blower casing, for example—may have a hardness of 150 Brinell Hardness (BHN) and a tensile strength measured in a range of from about 40 to about 50 kPa per square millimeter (kPa/mm²). In another embodiment, a suitable ductile iron casting may have a hardness of 250 BHN and a tensile strength in a range from about 66 to about 87 kPa/mm².

The properties enumerated above enable ductile iron to better tolerate the stresses of compressor wheel-burst. Accordingly, in some embodiments, the air inlet may be made of ductile iron. In these and other embodiments, one or both of the turbine casing and the blower casing may be made—wholly or partially—of ductile iron. Like the air inlet described hereinabove, one or both of the turbine casing and the blower casing may be single-walled, to reduce manufacturing cost and enhance serviceability.

The reader may note that the relative damping capacity of ductile iron, 5 to 20, is significantly less than that of grey cast iron, at 20 to 100. However, the inventors herein have concluded that damping in the turbine casing does not play a major role in turbocharger rotor dynamics. Therefore, the reduction in damping caused by the use of ductile iron in place of grey cast iron is not an issue.

In some embodiments, the air inlet, the turbine casing, and the blower casing may be sufficient in gauge and material strength to contain one or more fragments of the compressor wheel with a total kinetic energy of 110 kilojoules (kJ), following a compressor wheel burst. In other embodiments, the gauge and material strength of these components may be configured for 20% over-speed containment, corresponding to a 44% increase in kinetic energy—e.g., 158 kJ. In one approach, the gauge of the ductile iron used for the air inlet, turbine casing, and blower casing, may be computed based on a simulated compressor-wheel burst event that releases a predicted amount of energy. In some examples, the computed gauge may be 9.7 to 12.7 millimeters (mm).

Returning to FIG. 2, the bearings support the shaft, such that the shaft may rotate at a high speed with reduced friction. The shaft may be rotationally mounted in the bearings. A compressor wheel 24 is mechanically coupled to a turbine disc 22 through the shaft. The compressor wheel in FIG. 1 includes a vaned diffuser 32; in other embodiments, a vaneless diffuser may be used.

Exhaust gas may enter through an inlet of the turbine. A nozzle ring 44 may include airfoil-shaped vanes arranged circumferentially to form a complete 360° assembly. The nozzle ring may direct the exhaust gas to a turbine disc/blade assembly, including blades 46 and the turbine disc, coupled to the shaft. In some embodiments, the turbine disc and blades may be an integral component, known as a turbine blisk.

The blades may be airfoil-shaped blades extending outwardly from the turbine disc, which rotates about the centerline axis of the turbocharger. An annular shroud 50 is coupled to the casing at a shroud mounting flange 52 and arranged so as to closely surround the blades and thereby define a flowpath boundary for the exhaust stream flowing through the turbine.

The illustrated turbine is an axial turbine, as the exhaust flow impels on the turbine blades in an axial direction relative to the center axis of the turbocharger. However, in some embodiments, the turbine stage may be a radial turbine. Driven by expanding exhaust gas from the engine (e.g., engine 14 shown in FIG. 1), the turbine disc spins inside the casing, which surrounds the turbine disc. In one example, the casing may be single-walled.

A compressor casing, or compressor portion of the casing, may include or define an air inlet 34. The compressor casing is coupled to or formed with a blower casing 36. In the illustrated embodiment, the air inlet may be single-walled and admits air to the compressor wheel and to provide clearance for rotation of the compressor wheel. The air inlet is formed (e.g., disposed) circumferentially around the compressor wheel. The air inlet has an inner surface with a diameter sufficient to create a space large enough to accommodate an outer diameter of the compressor wheel. The inner diameter of the air inlet may be larger than the outer diameter of the compressor wheel to provide clearance for the compressor wheel to rotate freely within the air inlet. The blower casing (which may be a scroll casing) may be single-walled. The blower casing receives compressed air from the compressor wheel. The blower casing may be coupled to the air inlet with a plurality of bolts 38 in a radially symmetric arrangement. In one example, six bolts may couple the air inlet to the blower casing. Both the blower casing and the compressor casing have walls formed from selected materials, and a defined thickness. While the thicknesses of the walls may vary from location to location, the combination of the wall thickness and material strength are selected to have a burst-strength at selected portions.

FIGS. 3-12 show different embodiments of a turbocharger casing. For example, FIG. 3 shows an embodiment of a compressor casing including an integrated air inlet and blower casing. FIGS. 4-5 show a first embodiment of a turbine casing, the turbine casing included in the turbocharger casing. FIG. 6 shows a second embodiment of the turbine casing. FIGS. 7-12 show an embodiment of a split (e.g., divided) turbocharger casing. Specifically, the turbocharger casing may include a separate compressor casing and turbine casing coupled together via an intermediate spacer. FIGS. 3-12 may include similar components as described above with regard to FIG. 2. As such, similar components may be labeled similarly and not re-described with reference to FIGS. 3-12 in the interest of brevity. Additionally, FIGS. 3-12 include a coordinate axis 60 including a vertical axis 62, a horizontal axis 64, and a lateral axis 66. FIGS. 3-12 are drawn approximately to scale.

FIG. 3 shows a schematic 300 of a cross-section of a compressor casing 302. The compressor casing includes an air inlet and a blower casing. The air inlet is annular and centered along the rotational axis 70 of the turbocharger (the rotational axis 70 is also the rotational axis of the compressor casing and compressor wheel). The air inlet includes an inner diameter and an outer diameter. An air inlet wall 304 defining the air inlet has a thickness 306. The thickness is defined between the inner diameter and the outer diameter of the air inlet. The thickness may be selected based on a need for containment during a compressor wheel burst event. The thickness may be based on a burst-strength for retaining one or more fragments of the compressor wheel under a burst condition. The thickness may not be uniform, but may be selected to be sufficiently thick and/or sufficiently strong at a determined location based at least in part on the expected burst condition at that location.

The burst condition may result in a high-energy fragment, such as a fragment of the compressor wheel, being released and impacting the wall of the air inlet when the compressor is rotating at a relatively high speed (e.g., at 75% max speed or above). For example, burst events or burst conditions may include instantaneous release of a plurality of compressor-wheel fragments behind the air inlet—two to five fragments, in one example. Burst conditions may occur if there is a malfunction of the compressor wheel, or due to the introduction of a foreign object into the compressor. In one example, one fragment of the compressor wheel may be released during the burst condition. The released fragment may in turn cause additional wheel fragments to be released at high velocities. In another example, the entire compressor wheel may be released during a burst condition. Thus, “burst condition” refers to a state where a compressor is operating, e.g., at maximum RPM or otherwise, and all or part of the compressor wheel is subject to an unintended release so as to come into contact with the wall. The air inlet wall may have increased burst-strength that is a function of increased thickness of the wall of the air inlet which surrounds the compressor wheel and/or on the material forming the wall. As such, increasing the thickness may increase the burst-strength of the air inlet wall. A determined burst-strength need may be determined by empirical testing and/or modeling (e.g., finite-element analysis). The thickness may be chosen for the desired burst-strength such that the wall of the air inlet may retain compressor fragments released during the burst condition. That is, the fragments may be prevented from passing through the air inlet wall and entering the blower casing.

The wall of the air inlet may be continuous with a wall 308 of the blower casing (e.g., blower casing wall). The blower casing may form a volute of the compressor. As shown in FIG. 3, the illustrated blower casing wall is continuous with and adjacent to the air inlet wall. Mechanical coupling components may not be present to couple the two walls (e.g., the air inlet and blower casing walls) to each other. An interface between the air inlet and the blower casing may be continuous without any joints, coupling flanges, or mechanical couplers. The compressor casing is formed together as one piece. For example, the compressor casing may be manufactured by a single casting to form only one, single, monolithic, continuous and unitary part without detachable joints or components. Having an integrated compressor casing without joints or coupling interfaces may reduce the number of reduced-strength points. As a result, the compressor casing durability may be relatively higher than it otherwise would be. Additionally, the compressor casing may have increased containment capability in the event of a compressor wheel burst event.

In an example, the average thickness of the wall of the air inlet may be substantially the same as an average thickness of the blower casing wall. In another example, the average thickness of one wall may differ from the average thickness of the other wall. There may then be a combined average thickness, determined by material and by burst-strength need, and that combined average thickness may achieved through the selection of thickness of both walls. This might be useful in situations where the materials of the walls are dissimilar in their burst-strength capabilities. It may be useful to select one material for strength and another for ductility, for example.

Further, as shown in FIG. 3, there is a radius of curvature between the air inlet wall and the blower casing wall. For example, the air inlet wall and the blower casing wall intersect (or continue from one to the other) at a curved edge. In some examples, the ratio of the wall thickness may change along the radius of curvature. Specifically, a ratio of a thickness of the air inlet wall to a thickness of the blower casing wall may be a function of the radius of curvature between the air inlet wall and the blower casing wall and a material burst-strength of the air inlet wall and the blower casing wall, the material burst-strengths being defined as a burst-strength sufficient to retain one or more fragments of the compressor wheel under a burst condition. The burst-strength of the air inlet wall and the blower casing wall may be based on the material of the walls. In one example, the air inlet wall may be made of a more ductile material than the blower casing wall. In another example, the blower casing wall may be made of a more ductile material than the air inlet wall. As another example, the ratio of the thickness of the air inlet wall to the thickness of the blower casing wall decreases along the radius of curvature in a direction from the air inlet and toward the compressor wheel. In another example, the ratio of the thickness of the air inlet wall to the thickness of the blower casing wall increases along the radius of curvature in the direction from the air inlet and toward the compressor wheel.

FIG. 4 shows a schematic 400 of a cross-section of a first embodiment of a turbine casing (e.g., a turbine portion of a turbocharger casing) 402. The turbine casing 402 includes a shroud 404 (e.g., shroud component of the turbine casing). The shroud surrounds a turbine disc (not shown in FIG. 4) housed within the turbine casing. The shroud is annular shaped (e.g., may be an annular ring) and is centered on the rotational axis 70 of the turbocharger (the rotational axis is also the rotational axis of the turbine). As such, the shroud has an inner diameter and an outer diameter. Additionally, the shroud has a longitudinal axis 406, the longitudinal axis parallel to the rotational axis. As shown in FIG. 4, the shroud has a rectangular cross-section having a thickness 408. The thickness is defined perpendicular to a longitudinal axis of the shroud. The thickness is also defined between the inner diameter and the outer diameter of the shroud. As shown in FIG. 4, the thickness is uniform along the cross-section and along a length of the shroud, the length defined along the longitudinal axis of the shroud. Said another way, the thickness at a distal end 412 (e.g., first end) of the shroud is substantially the same as the thickness at a proximal end 414 (e.g. second end) of the shroud. The distal end and the proximal end are defined relative to the shaft and turbine disc of the turbine. For example, the proximal end may be closer to the turbine disc than the distal end. Further, the proximal end is closer to the compressor than the distal end. The thickness may be based on a burst-strength for retaining one or more fragments of the turbine disc under a burst condition.

The shroud has a burst-strength that is optimized or otherwise configured to withstand an impact of a high-energy fragment, such as a fragment of a turbine disc, blade, or blisk (combined turbine disc and blade) that may be released during a burst condition of the turbine. Burst conditions may occur if there is a malfunction of the turbine structure, or due to the introduction of a foreign object into the turbine. In some burst conditions, one fragment of the turbine disc may originally be released, and the release of the first fragment may cause additional fragments of the disc to be released. In some embodiments, the entire disc may be released during a burst condition. Thus, “burst condition” refers to a state where a turbine is operating, e.g., at maximum RPM or otherwise, and all or part of the disc is subject to an unintended release so as to come into contact with the shroud. In another example, the burst condition may refer to a state when the turbine is spinning at a relatively high speed (e.g., at 75% of maximum speed or above) and/or when a released fragment travels with a relatively high amount of energy that may penetrate a turbine casing not including a shroud. Specifically, the shroud may have increased burst-strength that is a function of increased thickness of the shroud surrounding the turbine disc (i.e., the burst-strength of the shroud surrounding the turbine disc is increased due to its greater thickness relative to a thinner material). The increased burst-strength of the shroud may retain the one or more turbine disc fragments within the shroud, thereby preventing their release to other components of the turbocharger and/or engine.

As shown in FIG. 4, the shroud is continuously integrated with a remainder of the turbine casing. For example, the shroud and the remainder of the turbine casing are continuously integrated with one another such that the shroud is formed as one piece with the remainder of the turbine casing. Said another way, there may be no bolts, material breaks, or joints between the shroud and the remainder of the turbine casing. The remainder of the turbine casing is shown generally at 410, the remainder of the turbine casing extending radially outwardly from the shroud and the rotational axis. The remainder of the turbine casing may be referred to herein as an exhaust casing. As such, the exhaust casing and the shroud are integrated and formed as one piece. The remainder of the turbine casing and the shroud are integrated together at the distal end of the shroud. Specifically, a wall of the remainder of the turbine casing is continuous with the shroud. The turbine casing does not include a mechanically coupled (e.g., bolted) joint between the shroud and the remainder of the turbine casing. Instead, the turbine casing is formed as one piece. The entire turbine casing may be manufactured in a single casting. The single turbine casing casting incorporates passages for exhaust gas and provides containment capability.

The integrated turbine casing allows for fewer parts and increased strength against turbine disc burst due to fewer joints. Further, the turbine casing may be one continuous material. By increasing the thickness of the shroud, a less expensive material over a traditional higher strength shroud material may be utilized. As a result of fewer parts and cheaper material costs, the integrated turbine casing may have a reduced cost over traditional non-integrated turbine casings. Further, decreasing the number of joints and coupled parts reduces a potential for exhaust leaks from the turbine casing.

FIG. 5 shows a schematic 500 of a cross-section of the first embodiment of the turbine casing 402 which further includes a water circulation passage 502 positioned in the shroud. The water circulation passage in the illustrated embodiment is an annular passage running along a circumferential edge of the shroud. As a result, thermal transfer fluid or coolant may flow through the shroud and around at least a portion of the edge circumference of the shroud. The thermal transfer fluid may exchange heat with the shroud such that heat is removed from the shroud and transferred to the fluid. After passing through the shroud, the fluid may return to a water cooling system of the engine. In one example, the water cooling system may include a pump which pumps the fluid into the shroud at the distal end and then back to a heat exchanger which removes the transferred heat from the water. In another example, the water cooling system may be the same as the engine cooling system. In yet another example, the water cooling system may be a dedicated water cooling system for the turbocharger. The water circulation passage may enter and exit the turbine casing directly through the shroud. In another example, the water circulation passage may also pass through at least a portion of the remainder of the turbine casing such that cooling is provided to shroud and at least the portion of the remainder of the turbine casing.

Suitable thermal transfer fluids may be selected with reference to the specific application, and can include water or air. Where air is used as the thermal transfer fluid, a thermal transfer structure may be used to conduct heat or thermal energy. A suitable thermal transfer structure may include radiator fins, a heat sink, a heat pipe, and the like. A thermally managed shroud may control thermal expansion and the resultant thermal stress on the shroud during turbocharger operation. By transferring heat from the exhaust gases flowing through the turbine, shroud degradation due to thermal stresses may be reduced.

FIG. 6 shows a schematic 600 of a cross-section of a second embodiment of a turbine casing 602. The turbine casing includes a shroud 604. The shroud surrounds a turbine disc (not shown in FIG. 6) housed within the turbine casing. The shroud is annular (e.g., may be an annular ring) and is centered on the rotational axis 70 of the turbocharger (the rotational axis is the rotational axis of the turbine). The shroud has a longitudinal axis 606, the longitudinal axis parallel to the rotational axis. Additionally, the shroud has distal end 608 and a proximal end 610, the distal end further away from the turbine disc and the shaft than the proximal end. The proximal end may be positioned such that it directly surrounds the turbine disc while the distal end is positioned away from the turbine disc and the compressor.

As shown in FIG. 6, the shroud has a proximal end thickness 612 that is greater than a distal end thickness 614. The proximal end thickness and the distal end thickness are perpendicular to the longitudinal axis. The proximal end thickness may be based on a burst-strength for retaining one or more fragments of the turbine disc under a burst condition, as described above. Additionally, the proximal end thickness may be based on a thickness 618 of a flange 616 of the turbine casing.

As shown in FIG. 6, the flange is integrated with the remainder of the turbine casing (e.g., the portion of the turbine casing not including the shroud). The flange extends along an entire length of the shroud. Specifically, the flange extends all the way from the distal end to the proximal end of the shroud. Additionally, the flange is positioned at an outer face of the shroud with respect to the rotational axis. The flange surrounds the shroud. Said another way, the shroud is interior to the flange. The shroud is coupled to the flange at the distal end of the shroud and a distal end of the flange (e.g., distal end relative to the turbine disc). The shroud and the flange may be mechanically coupled to one another through mechanical couplers (e.g., bolts). In another example, the shroud and the flange may be welded together at the distal end of the shroud.

The flange may provide additional containment during a burst event. Specifically, together the flange and the shroud may be configured to provide adequate containment during a burst event to reduce damage to the turbocharger. The thickness of the flange and the proximal end thickness of the shroud may be selected for a specific burst-strength, as described above. Since the flange provides an extra barrier and additional containment, the proximal end thickness of the shroud may be smaller than turbine casings that do not have a flange extending across the proximal end of the shroud. In one example, the proximal end thickness may be larger than the thickness of the flange and the distal end thickness of the shroud. In another embodiment, the proximal end thickness may be substantially the same as the thickness. The thicknesses of the shroud, or at least the proximal end thickness of the shroud, may be smaller than a standard (e.g., traditional) turbocharger shroud thickness that does not have a flange extending over the entire length of the shroud (e.g., all the way from the distal to the proximal end of the shroud).

The flange may provide secondary containment to the turbine casing. In this way, the shroud and the flange may be referred to as a primary containment portion and a secondary containment portion, respectively, of the turbine casing. In some embodiments, the shroud and the flange may be made of different materials (e.g., the shroud material may be more expensive than the flange material due to the shroud material being stronger and/or more resistive to burst events than the flange material). Decreasing the thickness of the shroud due to the presence of the flange may decrease the cost of material.

In one embodiment, a compressor casing and a turbine casing of a turbocharger casing are formed together as one undivided turbocharger casing. For example, the casing shown in FIG. 2 may be one continuous casing including any one of the turbine casings and compressor casings described above in FIGS. 2-6. Said another way, the turbocharger casing may be formed as one piece without out any joints or mechanical fasteners between the compressor casing and the turbine casing. The undivided turbocharger casing may be manufactured as a single casting, thereby reducing a number of joints and mechanical fasteners.

The integrated turbocharger casing (with integrated and continuous compressor and turbine portions of the single casing) will only work in turbochargers having the same geometry. As a result, a different casing design may be required for each turbocharger size. For example, different turbochargers (e.g., for different engines or different sized vehicles) may have varying shaft lengths and bearing diameters. As a result, a different and specific turbocharger casing sized for the specific shaft length and bearing diameter (or size) may be used for each turbocharger. As a result of not having a universal turbocharger casing, servicing time of a degraded turbocharger casing may increase due to varying component sizes. Additionally, different turbocharger casings may have to be produced for the different sized turbochargers. This may result in increased turbocharger casing production costs.

Thus, in another embodiment, the turbocharger casing may include a compressor casing and turbine casing which are separate and coupled to one another through an intermediate piece. In one example, the intermediate piece may be referred to as an intermediate spacer and may have a size based on the turbocharger size. For example, two different turbochargers with two different shaft lengths may have the same turbine casing and compressor casing. However, each of the turbochargers may have different sized intermediate spacers. For example, an intermediate spacer of one of the two turbochargers may be longer (or have a greater width) than the other turbocharger of the two turbochargers. In this way, one turbocharger casing may be adapted for different sized turbochargers without manufacturing different turbine and compressor casings. Additional examples of different turbochargers utilizing different intermediate spacers are presented below.

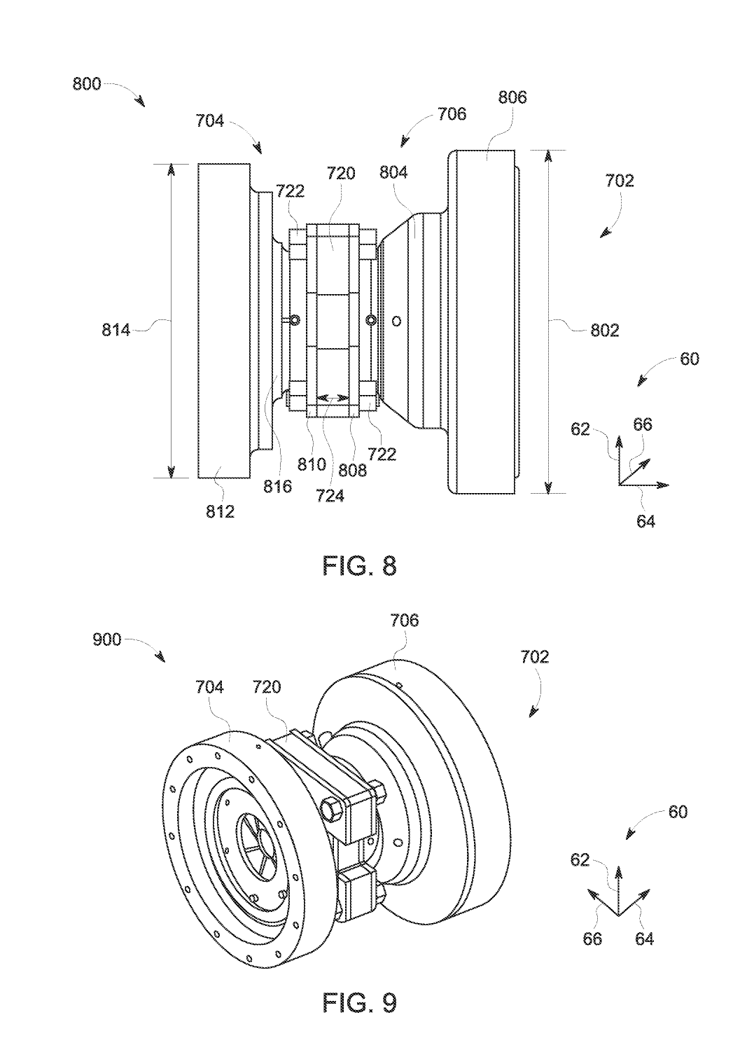

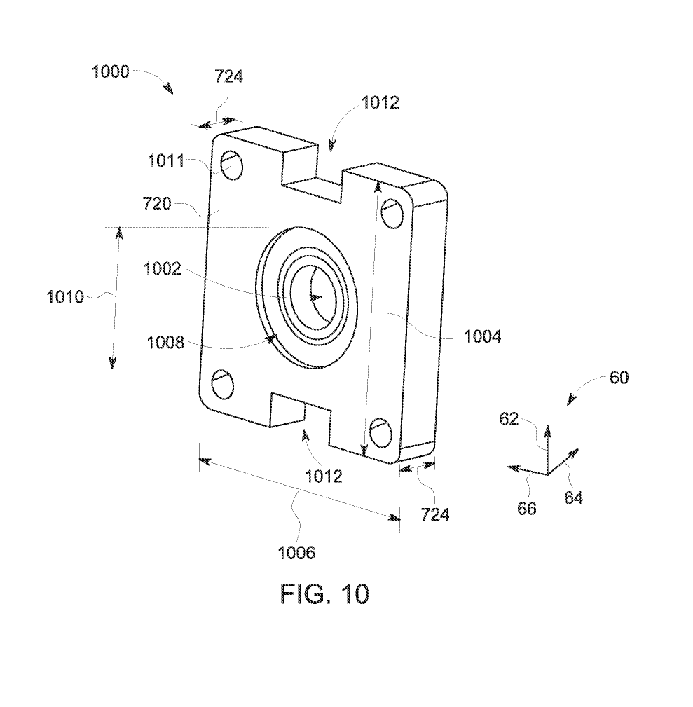

FIGS. 7-12 show a split (e.g., divided) turbocharger casing 702 and its associated components. FIG. 7 shows a schematic 700 of a cross-sectional side-view of the turbocharger casing. FIGS. 8-9 show three-dimensional side (schematic 800) and isometric (schematic 900) views, respectively, of the turbocharger casing. FIGS. 10-12 show isometric views of an intermediate spacer (schematic 1000), a compressor casing (schematic 1100), and a bearing bush (schematic 1200), respectively. The turbocharger casing includes a turbine casing component and a compressor casing component. The turbine casing and the compressor casing may have some similar features (e.g., shroud designs) as the turbine and compressor casings described above with reference to FIGS. 2-6. For example, any combination of the turbine shroud or compressor casing designs presented above may be incorporated into the individual turbine casing and compressor casing.

Regarding the bearing bush, suitable bush materials may be formed from metallic materials, bi-metallic materials, ceramics and cements. These material selections may be based at least in part on application specific criteria. Further, the manufacturing process, to include surface finish and coatings, also may be selected based at least in part on application specific criteria. As used herein, application specific criteria refers to the operating conditions and duty life of the referenced component.

Additionally, the turbine casing 704 and compressor casing 706 shown in FIGS. 7-12 may be portions of a complete turbine casing and compressor casing as shown in FIGS. 3-6. For example, the turbine casing may be the portion of the turbine casing that surrounds a turbine disc and then couples to a remainder of the turbine casing (such as the volute or distal portion of the turbine casing shroud). Similarly, the compressor casing may be the portion of the compressor casing that surrounds the compressor wheel and then couples to a remainder of the compressor casing (such as the blower casing or compressor volute). In some examples, the remainder of the turbine casing and/or the compressor casing may resemble the turbine and compressor casings shown in FIGS. 3-6. Thus, a compressor volute and turbine volute may couple to or be continuously integrated with the turbine casing and compressor casing as shown in FIGS. 7-12.

As described above, the turbine casing may house a turbine disc and the compressor casing may house a compressor wheel. The compressor wheel and turbine disc are mechanically coupled to one another via a shaft 708. The shaft 708 has a shaft length 710 specific to the turbocharger (e.g., specific to the turbocharger size and/or model). As shown in FIG. 7, the shaft length is measured from where the shaft couples to the turbine disc to a rear end of a rotor cap). For example, the shaft length may be the entire length of the shaft. A portion of the shaft length that is between the turbocharger bearings 30 is referred to as a bearing span 712 of the turbocharger. More specifically, the bearing span is defined between a first set of bearings 714 proximate to the turbine casing and a second set of bearings 716 proximate to the compressor casing. The bearing span is based at least partially on the shaft length. The bearing span may also be based on a size of the bearings. The bearings surround the shaft and have a bearing diameter 718.

As shown in FIGS. 7-9, an intermediate spacer 720 is positioned between the turbine casing and the compressor casing and centered along the rotational axis 70. The intermediate spacer surrounds the shaft such that the shaft runs through a aperture 1002 in a center of the intermediate spacer (as seen in FIG. 10, described further below). The intermediate spacer directly couples the turbine casing and the compressor casing to one another through a plurality of mechanical fasteners (e.g., bolts, nuts, or screws). In one example, as shown in FIGS. 7-9, the mechanical fasteners are a plurality of bolts 722.

The intermediate spacer has a width 724. The dimensions of the intermediate spacer are best seen in schematic 1000 of FIG. 10. As seen in FIG. 10, the intermediate spacer also has a height 1004 and length 1006. The height is defined in a direction of the vertical axis 62 and the length is defined in a direction of the lateral axis 66, the lateral axis and vertical axis both perpendicular to the rotational axis of the turbocharger. In one example, the height and the length may be substantially equal such that the intermediate spacer is square-shaped. In another example, the height and the length may not be equal and the intermediate spacer may be rectangular. The width of the intermediate spacer is parallel to the rotational axis and is based on the shaft length. The width of the intermediate spacer is also based on the bearing span. For example, the width may be larger for turbochargers having a longer shaft length and/or longer bearing span.

Also seen in FIG. 10, the intermediate spacer includes a central aperture 1002 positioned in the center of the spacer. A diameter of the central aperture may be slightly larger than a diameter of the shaft such that the central aperture fits around the shaft. The intermediate spacer includes a depression 1008 centered around the central aperture 1002. The depression may be depressed from an outer surface of a side of the intermediate spacer and toward an interior of the intermediate spacer. The depression has a depression diameter 1010 centered with respect to a center of the central aperture and the rotational axis. The intermediate spacer may be symmetrical such that the intermediate spacer includes a plurality of depressions that are about the same size on either side of the intermediate spacer.

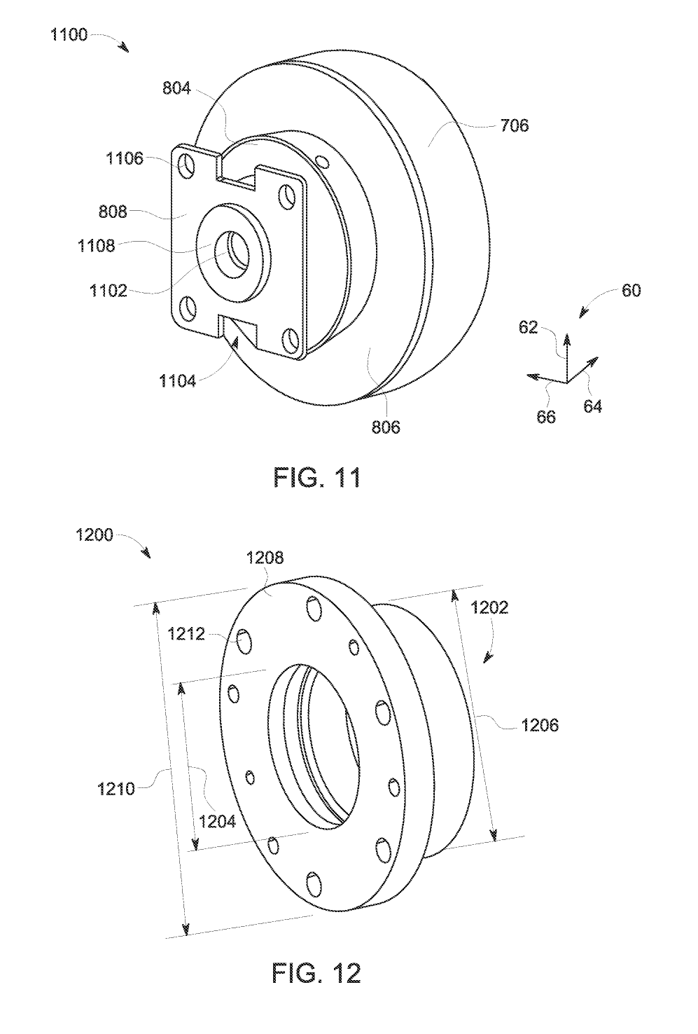

The intermediate spacer also includes a plurality of coupling apertures 1011 positioned around an exterior perimeter of the intermediate spacer. The coupling apertures may extend through the entire width of the intermediate spacer. As shown in FIG. 10, the intermediate spacer includes four coupling apertures that correspond to four matching apertures in the compressor housing and the turbine housing (see FIG. 11, explained further below). In another embodiment, the intermediate spacer may include more or less than four coupling apertures. As shown in FIG. 10, the intermediate spacer includes two notches 1012 positioned at a top face and bottom face of the intermediate spacer. In one example, the notches may allow for oil passages to run through the intermediate spacer. In another embodiment, the intermediate spacer may not include notches.

Turning to FIG. 11, a schematic 1100 of the compressor casing is shown. The compressor casing has a cylindrical end portion 806 with an outer diameter 802 (shown in FIG. 8). The cylindrical end portion has an open end which may couple to a blower casing and air inlet portions of the compressor casing. The compressor casing also includes a tapered cylindrical body 804. The tapered cylindrical body is coupled to a flange 808 of the compressor casing. The flange is rectangular with a central aperture 1102 in which the shaft passes through. The flange also includes two notches 1104 which correspond to the notches 1012 of the intermediate spacer. However, in alternate embodiments, the flange may be completely rectangular without any notches. The flange also includes a plurality of coupling apertures 1106 which correspond to the plurality of coupling apertures 1011 of the intermediate spacer. Specifically, as shown in FIG. 11, the flange includes four coupling apertures. However, in alternate embodiments the flange may include more or less than four coupling apertures. The coupling apertures may align with the coupling apertures of the intermediate spacer so that the intermediate spacer and the compressor casing may be mechanically coupled to one another, as shown in FIGS. 7-9. For example, as shown in FIGS. 8-9, bolts 722 (or other fasteners such as bolts, nuts, or the like), pass through the coupling apertures of the compressor casing and the coupling apertures of the intermediate spacer.

Additionally, the flange of the compressor casing includes a raised ring 1108 centrally aligned with the rotational axis and surrounding the central aperture. The raised ring is a projection extending outwardly from a surface of the flange. The raised ring has an inner diameter corresponding to the diameter of the central aperture and an outer diameter corresponding with the depression diameter of the intermediate spacer. As such, the depression diameter and the outer diameter of the raised ring may be sized such that the raised ring fits within the depression of the intermediate spacer. Further, a height (e.g., distance from surface of the flange to outer surface of the raised ring) of the raised ring may be substantially the same as a depth of the depression of the intermediate spacer such that the surface of the flange contacts a corresponding surface of the intermediate spacer when the two parts are mated (e.g., coupled) to one another. Said another way, the flange and the surface (e.g., side surface) of the intermediate spacer may have face-sharing contact with one another.

The turbine casing may have similar features as described above for the compressor casing. For example, the turbine casing also includes a flange 810, a cylindrical end portion 812 having an outer diameter 814, and a cylindrical body 816 (as best seen in FIGS. 8-9).

Turning to FIGS. 8-9, three-dimensional side (schematic 800) and isometric (schematic 900) views are shown of the turbocharger casing. Specifically, schematic 800 and schematic 900 show the intermediate spacer coupled to and between the compression casing and the turbine casing. The flange of the turbine casing is directly coupled to a first side of the intermediate spacer and the flange of the compressor casing is directly coupled to a second side of the intermediate spacer, the second side opposite the first side.

As best seen in FIG. 8, the cylindrical body of the turbine casing includes a portion with a constant diameter smaller than the diameter of the cylindrical end portion. The cylindrical body then tapers from the constant diameter portion to the flange of the turbine casing such that the diameter of the cylindrical body decreases from the constant diameter portion to the flange of the turbine casing.

The width of the intermediate spacer dictates a distance between the compressor casing and the turbine casing. For example, the compressor casing and the turbine casing may be spaced farther apart from one another in a turbocharger casing including an intermediate spacer having a larger width compared to an intermediate spacer having a smaller width. The intermediate spacer with the larger width may accommodate longer shafts than the intermediate spacer with the smaller width.

As discussed above with reference to FIG. 10, the intermediate spacer has a height and length. The height and the length may be at least partially based on the outer diameter of the turbine casing and the outer diameter of the compressor casing.

As seen in FIG. 7, the turbocharger casing may include a first bearing bush 730 positioned within the turbine casing and a second bearing bush 732 positioned within the compressor casing. More specifically, the first bearing bush is positioned within the cylindrical body of the turbine casing and the second bearing bush is positioned within the tapered cylindrical body of the compressor casing.

FIG. 12 shows a schematic 1200 of a bearing bush 1202 (bearing bush 1202 may be the first bearing bush 730 and/or the second bearing bush 732 shown in FIG. 7). The bearing bush is annular with an inner diameter 1204 and an outer diameter 1206. A thickness of the bearing bush is defined between the inner diameter and the outer diameter. The bearing bush also includes a mounting flange 1208. The mounting flange is positioned at a first end of the bearing bush and extends outwardly from the inner diameter. The mounting flange has a flange diameter 1210, the flange diameter larger than the outer diameter of the bearing bush. A plurality of apertures 1212 are positioned around a circumference of the mounting flange, the apertures closer to an outer edge than an inner edge of the mounting flange. In one embodiment, the apertures are spaced evenly around the circumference of the mounting flange (such that they are equidistant from one another). In another embodiment, the apertures are not spaced equidistant from one another. Further, as shown in FIG. 12, the apertures include apertures of varying diameter (e.g., a first set of apertures with a first diameter and a second set of apertures with a second diameter different than the first diameter). In an alternate embodiment, all the apertures may have substantially the same diameter. In yet another example, the apertures may be spaced at different positions along the mounting flange relative to the outer edge of the mounting flange. Additionally, the mounting flange has a thickness, the apertures extending through the entire thickness of the mounting flange.

The first bearing bush 730 and the second bearing bush 732 may have the same general shape as shown in FIG. 12. However, the specific dimensions may be based on the shape and dimensions of the corresponding casing (e.g., the turbine casing or the compressor casing) in which the bearing bush is positioned. In another embodiment, the first bearing bush and the second bearing bush may have about the same dimensions as each other.

Returning to FIG. 7, the first bearing bush and the second bearing bush surround the shaft and the bearings, the bearings supporting the shaft. The inner diameter of the first bearing bush and the second bearing bush is based on the bearing diameter. The outer diameter of the first bearing bush corresponds to an inner diameter 734 of the turbine casing. The inner diameter is an innermost diameter of the cylindrical body. The mounting flange of the first bearing bush is directly coupled to the turbine casing through the apertures of the first bearing bush, corresponding mounting apertures of the turbine casing, and a plurality of mechanical fasteners (e.g., bolts).

Similarly, the outer diameter of the second bearing bush corresponds to an inner diameter 736 of the compressor casing. The inner diameter of the compressor casing is an innermost diameter of the tapered cylindrical body. The mounting flange of the second bearing bush is directly coupled to the compressor casing through the apertures of the second bearing bush, corresponding mounting apertures of the compressor casing, and a plurality of mechanical fasteners. The first bearing bush and the second bearing bush are directly coupled to their corresponding casings without any additional parts separating the corresponding bearing bush and casing from one another. Said another way, the mounting flange of the first bearing bush has face-sharing contact with a corresponding portion of the turbine casing and the mounting flange of the second bearing bush has face-sharing contact with a corresponding portion of the compressor casing.

In this way, a first turbocharger may include a first turbocharger casing including a first turbine casing, a first compressor casing, a first intermediate spacer, and a first set of bearing bushing. A second turbocharger may include a second turbocharger casing including a second turbine casing, a second compressor casing, a second intermediate spacer, and a second set of bearing bushing. The first turbine casing may be the same as the second turbine casing and the first compressor casing may be the same as the second compressor casing. For example, the first and second turbine casings may have substantially similar, or the same, geometry and size dimensions as each other; and, the first and second compressor casings may have substantially similar, or the same, geometry and size dimensions as each other. The first turbocharger may have a longer shaft length and larger bearing diameter than the second turbocharger. The first intermediate spacer may have a larger width (e.g., width 724 shown in FIGS. 7-10) than the second intermediate spacer. Additionally, the first set of bearing bushing may have a larger inner diameter (e.g., inner diameter 1204 shown in FIG. 12) than the second set of bearing bushing to accommodate the larger bearing diameter of the first turbocharger. In this way, the same turbocharger casing may be used in two different turbochargers having different shaft lengths and bearing diameters. By utilizing different intermediate spacers and bearing bushing based on the specific shaft lengths and bearing diameters of the turbochargers, the same turbocharger casing may be adapted for both turbochargers. As a result, manufacturing costs may be decreased while also increasing the ease of servicing individual turbochargers.

As one embodiment, an apparatus comprises a compressor casing for a turbocharger, the compressor casing defining an air inlet and having a blower casing component, the air inlet configured to admit air to a compressor wheel mechanically coupled to a turbine disc via a shaft, the turbine disc rotatable about a rotational axis of the turbocharger and a turbine casing for the turbocharger, the turbine casing housing the turbine disc, the turbine casing comprising a shroud component surrounding at least a portion of the turbine disc.

A wall of the blower casing and a wall of the air inlet are adjacent to and continuous with each other along at least a section, and at least one of the wall of the air inlet, the wall of the blower casing, or the combination of the wall of the blower casing and the wall of the air inlet, and each of the blower casing wall and the air inlet wall have a selected thickness and each comprises a selected material such that the combination of the wall of the blower casing and the wall of the air inlet will exhibit a burst-strength sufficient to retain one or more fragments of the compressor wheel under a burst condition. At least one of the wall of the air inlet or the wall of the blower casing comprise a ductile metal. Further, the thickness of the wall of the air inlet may differ from the thickness of the wall of the blower casing.

Additionally, the air inlet is disposed circumferentially around the compressor wheel, the air inlet having an inner diameter larger than an outer diameter of the compressor wheel in order to provide clearance for rotation of the compressor wheel about the rotational axis.

The shroud is continuously integrated with a remainder of the turbine casing and the shroud has a rectangular cross-section having a thickness, the thickness defined perpendicular to a longitudinal axis of the shroud and based on a burst-strength for retaining one or more fragments of the turbine disc under a burst condition, the longitudinal axis parallel to the rotational axis of the turbocharger. In one example, the shroud is continuously integrated with the remainder of the turbine casing at a first end of the shroud, the first end further away from the turbine disc than a second end of the shroud. In one embodiment, the shroud has an inner surface that defines a water circulation passage extending through the shroud for cooling the shroud. The shroud is configured so that thermal fluid circulating through the water circulation passage will carry heat from the shroud to a location away from the shroud. The water circulation passage is an annular-shaped passage that extends along a circumferential edge of the shroud. The shroud comprises a heat transfer structure configured to transport heat energy from inside the shroud to a stream of air impinging on the heat transfer structure.

In another example, the shroud is coupled to a flange of the turbine casing, the flange integrated with the turbine casing and extending along a length of the shroud, the flange positioned at an outer face of the shroud with respect to the rotational axis of the turbocharger, the flange having a first thickness. The flange and the shroud are coupled to one another at a distal end of the flange and a distal end of the shroud and wherein the distal end of the shroud has a second thickness and a proximal end of the shroud has a third thickness, the third thickness larger than the second thickness and the first thickness of the flange.

In one example, the compressor casing and the turbine casing are formed together as one undivided turbocharger casing. In another example, the compressor casing and the turbine casing are separate and coupled to one another through an intermediate spacer centered along the rotational axis, the intermediate spacer having a width and surrounding the shaft, the width of the intermediate spacer selected based on a length of the shaft. The turbocharger further comprises a first bearing bush positioned within the turbine casing and a second bearing bush positioned within the compressor casing, the first bearing bush and second bearing bush surrounding bearings of the shaft, an inner diameter of the first bearing bush and the second bearing bush based on a diameter of the bearings.

The first bearing bush is positioned within the turbine casing, has an outer diameter corresponding to an inner diameter of the turbine casing, and has a first mounting flange defined by the first bearing bush wherein the first mounting flange defines a plurality of apertures configured to facilitate mounting of the first bearing bush to the turbine casing. The second bearing bush is positioned within the compressor casing, has an outer diameter corresponding to an inner diameter of the compressor casing, and has a second mounting flange defined by the second bearing bush wherein the second mounting flange defines a plurality of apertures for mounting the second bearing bush to the compressor casing.

In one embodiment, compressor casing and the turbine casing are not monolithic, but are coupled to one another through an intermediate spacer centered along the rotational axis, the intermediate spacer having a width and surrounding the shaft, the width of the intermediate spacer selected based on a length of the shaft. The intermediate spacer has a surface that defines two depressions that are about the same size as each other but disposed on opposing sides of the intermediate spacer.

As another embodiment, a turbocharger comprises a compressor casing comprising an air inlet and a blower casing formed as a single, unitary piece with an air inlet wall continuous with a blower casing wall, the air inlet configured to admit air to a compressor wheel of the turbocharger. The turbocharger further comprises a turbine casing housing a turbine disc mechanically coupled to the compressor wheel, the turbine casing comprising an annular shroud surrounding the turbine disc and an exhaust casing, the shroud integrated and formed as one piece with the exhaust casing, a thickness of the shroud being uniform along a length of the shroud. The thickness of the shroud is defined perpendicularly to a longitudinal axis of the shroud, the longitudinal axis of the shroud parallel to a rotational axis of the turbocharger. The thickness of the shroud is determined to have a burst strength for retaining one or more fragments of the turbine disc under a burst condition. In one example, the shroud includes an interior passage extending through and around the shroud for circulating thermal fluid, the thermal fluid transferring heat from the shroud and to a location away from the shroud.

As yet another embodiment, an apparatus comprises a compressor casing for a turbocharger, the compressor casing defining an air inlet and having a blower casing component, the air inlet configured to admit air to a compressor wheel mechanically coupled to a turbine disc via a shaft, where a ratio of a thickness of an air inlet wall to a thickness of a blower casing wall is a function of a radius of curvature between the air inlet wall and the blower casing wall and a material burst-strength of the air inlet wall and the blower casing wall. The apparatus further comprises a turbine casing for the turbocharger, the turbine casing housing the turbine disc, the turbine casing comprising a shroud component surrounding at least a portion of the turbine disc. In one example, the shroud is formed as one piece with a remainder of the turbine casing. In another example, the shroud is coupled to a flange extending along a length of the shroud on an opposite side of the shroud from the turbine disc. In one example, the air inlet wall comprises a more ductile material than the compressor casing wall. In another example, the ratio of the thickness of the air inlet wall to the thickness of the blower casing wall decreases along the radius of curvature in a direction from the air inlet and toward the compressor wheel.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

1. An apparatus, comprising:
a compressor casing for a turbocharger, the compressor casing defining an air inlet and having a blower casing component, the air inlet configured to admit air to a compressor wheel mechanically coupled to a turbine disc via a shaft, the turbine disc rotatable about a rotational axis of the turbocharger; and
a turbine casing for the turbocharger, the turbine casing housing the turbine disc, the turbine casing comprising a shroud component surrounding at least a portion of the turbine disc.

2. The apparatus of claim 1, wherein a wall of the blower casing component and a wall of the air inlet are adjacent to and continuous with each other along at least a section, and each of the wall of the blower casing component and the wall of the air inlet have a selected thickness and each comprise a selected material such that the combination of the wall of the blower casing component and the wall of the air inlet will exhibit a burst-strength sufficient to retain one or more fragments of the compressor wheel under a burst condition.

3. The apparatus of claim 2, wherein at least one of the wall of the air inlet or the wall of the blower casing comprise a ductile metal.

4. The apparatus of claim 2, wherein the thickness of the wall of the air inlet differs from a thickness of the wall of the blower casing.

5. The apparatus of claim 1, wherein the compressor casing and the turbine casing are formed together as one undivided, monolithic turbocharger casing.

6. The apparatus of claim 1, wherein the shroud component is integrated with a remainder of the turbine casing, and the shroud component has a cross-section having a thickness, the thickness being defined as perpendicular to a longitudinal axis of the shroud component and the thickness being determined to have a burst-strength for retaining one or more fragments of the turbine disc under a burst condition, the longitudinal axis parallel to the rotational axis of the turbocharger.

7. The apparatus of claim 6, wherein the shroud component is integrated with the remainder of the turbine casing at a first end of the shroud component, the first end being further away from the turbine disc than a second end of the shroud component.

8. The apparatus of claim 6, wherein the shroud component has an inner surface that defines a water circulation passage extending through the shroud component, and is configured so that thermal fluid circulating through the water circulation passage will carry heat from the shroud component to a location away from the shroud component.

9. The apparatus of claim 8, wherein the water circulation passage is an annular-shaped passage that extends along a circumferential edge of the shroud.

10. The apparatus of claim 6, wherein the shroud component comprises a heat transfer structure configured to transport heat energy from inside the shroud component to a stream of air impinging on the heat transfer structure.

11. The apparatus of claim 1, wherein the shroud component is coupled to a flange of the turbine casing, the flange integrated with the turbine casing and extending along a length of the shroud component, the flange positioned at an outer face of the shroud with respect to the rotational axis of the turbocharger, the flange having a first thickness.

12. The apparatus of claim 11, wherein the flange and the shroud component are coupled to one another at a distal end of the flange and a distal end of the shroud component and wherein the distal end of the shroud component has a second thickness and a proximal end of the shroud component has a third thickness, the third thickness larger than the second thickness and the first thickness of the flange.

13. The apparatus of claim 11, wherein the shroud component is an annular shroud surrounding the turbine disc, and a distal end of the shroud component is coupled at an outer surface to a flange of the turbine casing, the flange extending along a length of the shroud component from the distal end to a proximal end of the shroud component, the proximal end proximal to a blade of the turbine disc.

14. The apparatus of claim 1, further comprising a first bearing bush positioned within the turbine casing and a second bearing bush positioned within the compressor casing, the first bearing bush and second bearing bush surrounding bearings of the shaft, an inner diameter of the first bearing bush and the second bearing bush based on a diameter of the bearings.

15. The apparatus of claim 14, wherein the first bearing bush is positioned within the turbine casing and has an outer diameter corresponding to an inner diameter of the turbine casing, and further comprising a first mounting flange defined by the first bearing bush, wherein the first mounting flange defines a plurality of apertures configured to facilitate mounting of the first bearing bush to the turbine casing.

16. The apparatus of claim 14, wherein the second bearing bush is positioned within the compressor casing and has an outer diameter corresponding to an inner diameter of the compressor casing and further comprising a second mounting flange defined by the second bearing bush, wherein the second mounting flange defines a plurality of apertures for mounting the second bearing bush to the compressor casing.

17. The apparatus of claim 1, wherein the compressor casing and the turbine casing are not monolithic, but are coupled to one another through an intermediate spacer centered along the rotational axis, the intermediate spacer having a width and surrounding the shaft, the width of the intermediate spacer selected based on a length of the shaft.

18. The apparatus of claim 17, wherein the intermediate spacer has a surface that defines two depressions that are about the same size as each other but disposed on opposing sides of the intermediate spacer.

19. A turbocharger, comprising:
a compressor casing comprising an air inlet and a blower casing formed as a single, unitary piece with an air inlet wall continuous with a blower casing wall, the air inlet configured to admit air to a compressor wheel of the turbocharger; and
a turbine casing housing a turbine disc mechanically coupled to the compressor wheel, the turbine casing comprising an annular shroud surrounding the turbine disc and an exhaust casing, the shroud integrated and formed as one piece with the exhaust casing, a thickness of the shroud being uniform along a length of the shroud.

20. An apparatus, comprising:
a compressor casing for a turbocharger, the compressor casing defining an air inlet and having a blower casing component, the air inlet configured to admit air to a compressor wheel mechanically coupled to a turbine disc via a shaft, where a ratio of a thickness of an air inlet wall to a thickness of a blower casing wall is a function of a radius of curvature between the air inlet wall and the blower casing wall and a material burst-strength of the air inlet wall and the blower casing wall; and
a turbine casing for the turbocharger, the turbine casing housing the turbine disc, the turbine casing comprising a shroud component surrounding at least a portion of the turbine disc.
